(19) United States
(12) Patent Application Publication
(10) Pub. No.: US 2021/0149866 A1
(43) Pub. Date: May 20, 2021

(54) UNIVERSAL DATA INDEX FOR RAPID DATA EXPLORATION

(71) Applicant: GOOGLE LLC, Mountain View, CA (US)

(72) Inventors: Steven Talbot, Santa Cruz, CA (US); Colin Zima, Sanra Cruz, CA (US)

(73) Assignee: GOOGLE LLC, Mountain View, CA (US)

(21) Appl. No.: 16/690,069

(22) Filed: Nov. 20, 2019

(51) Int. Cl. G06F 16/22; G06F 16/2457; G06F 16/21

(52) U.S. Cl. CPC G06F 16/2272; G06F 16/221; G06F 16/211; G06F 16/24573

(57) ABSTRACT

Embodiments of the invention provide a novel and non-obvious method, system and computer program product for universal data index construction. In an embodiment of the invention, a universal data index construction method includes establishing a communicative coupling to a database by way of a database management system. The method additionally includes creating in an index in memory of a host computer, a union of field values in all columns of the database, with all meta-data for the columns of the database. In this regard, the index associates each of the values and each of the meta-data with a specific location in the database. The method further includes adding to the index, pair-wise field values as a co-occurrence list. Finally, the method includes issuing a query to the index without issuing a SQL WHERE statement to the database management system in order to produce a filtered query result.

### BACKGROUND OF THE INVENTION

### Field of the Invention

The present invention relates to the field of data analytics and more particular to query generation for business intelligence.

### Description of the Related Art

The term database refers to an organized collection of data, stored and accessed electronically by way of a computing system. A database management system (DBMS) in turn is a computer program that provides an interface between the database and one or more end users so as to facilitate the interaction by each end user with the database. A DBMS generally also provides an interface to other computer programs to access the data in the underlying database. Generally, speaking, end users and other computer programs interact with the database through the DBMS using query directives formed in conformance with a corresponding query language such as the venerable structured query language (SQL).

While the very basic use of SQL to query and manage data in a database is of no great difficulty for many end users, formulating more complex SQL queries is not for the faint of heart. More importantly, specifying a query irrespective of the mechanics of the actual query requires a strong understanding of the data in the database and the underlying relationships between the data. Generally, to locate specific data in a database, one must craft a SQL query incorporating a filter specifying a value for a particular field of a database record. The WHERE statement is the primary tool used in this instance. But, to conduct such a query first requires the query author to know a priori the name of the field for which the filter is to be applied and, to the extent that the sought-after value in the filter is present in a different field, or is related to a different value of a different field, the filter will fail. Of course, conducting extensive query operations on a database in order to comprehensively scour a database for desired records can be slow and resource intensive.

### BRIEF SUMMARY OF THE INVENTION

Embodiments of the present invention address deficiencies of the art in respect to data analytics and provide a novel and non-obvious method, system and computer program product for universal data index construction. In an embodiment of the invention, a universal data index construction method includes establishing a communicative coupling to a database by way of a database management system. The method additionally includes creating in an index in memory of a host computer, a union of field values in all columns of the database, with all meta-data for the columns of the database. In this regard, the index associates each of the values and each of the meta-data with a specific location in the database. The method further includes adding to the index, pair-wise field values as a co-occurrence list. Finally, the method includes issuing a query to the index without issuing a SQL WHERE statement to the database management system in order to produce a filtered query result.

In one aspect of the embodiment, the meta-data includes a name for each of the columns. In this regard, the query may include a query term associated with a column name of one of the columns. As well, the query may include a field value such that the issuance of the query produces a name of a column containing the field value as a reverse lookup of the name of the column based upon the field value. Even further, the query may include a first field value such that the issuing of the query produces a second field value from a corresponding one of the pair-wise field values of the co-occurrence list so as to locate the second field value as co-occurring with the first field value.

In another embodiment of the invention, a data analytics data processing system is configured for universal data index construction. The system includes a host computing system that has one or more computers, each with memory and at least one processor. The system also includes a database index persistent in the memory of the host computing system. Finally, the system includes a universal data index construction module. The module includes computer program instructions executing in the memory of the host computing system. The program instructions are enabled to establish a communicative coupling to a database by way of a database management system, to create in the database index in the memory of the host computing system, a union of field values in all columns of a database, with all meta-data for the columns of the database, the index associating each of the values and each of the meta-data with a specific location in the database, to add to the database index, pair-wise field values as a co-occurrence list and to issue a query to the database index without issuing a SQL WHERE statement to the database management system in order to produce a filtered query result.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for the generation and utilization of a universal database index for fast query searching of a database;

FIG. 2 is a schematic illustration of a data processing system configured for generating and utilizing a universal database index for fast query searching of a database; and,

FIG. 3 is a flow chart illustrating a process for generating a universal database index for fast query searching of a database.

### DETAILED DESCRIPTION OF THE INVENTION

Embodiments of the invention provide for the generation and use of a universal database index for fast query searching of a database. In accordance with an embodiment of the invention, a universal data index can be generated by opening a communicative connection to a database by way of a database management system. Thereafter, an index is created as a union of field values in all columns of the database, with all meta-data for the columns of the database. An association is then established within the index for each of the values and each of the meta-data with a specific location in the database. As well, pair-wise field values are added to the index as a co-occurrence list. Then, the universal data index is used by issuing a query to the index without issuing a structured query language (SQL) WHERE statement to the database management system in order to produce a filtered query result.

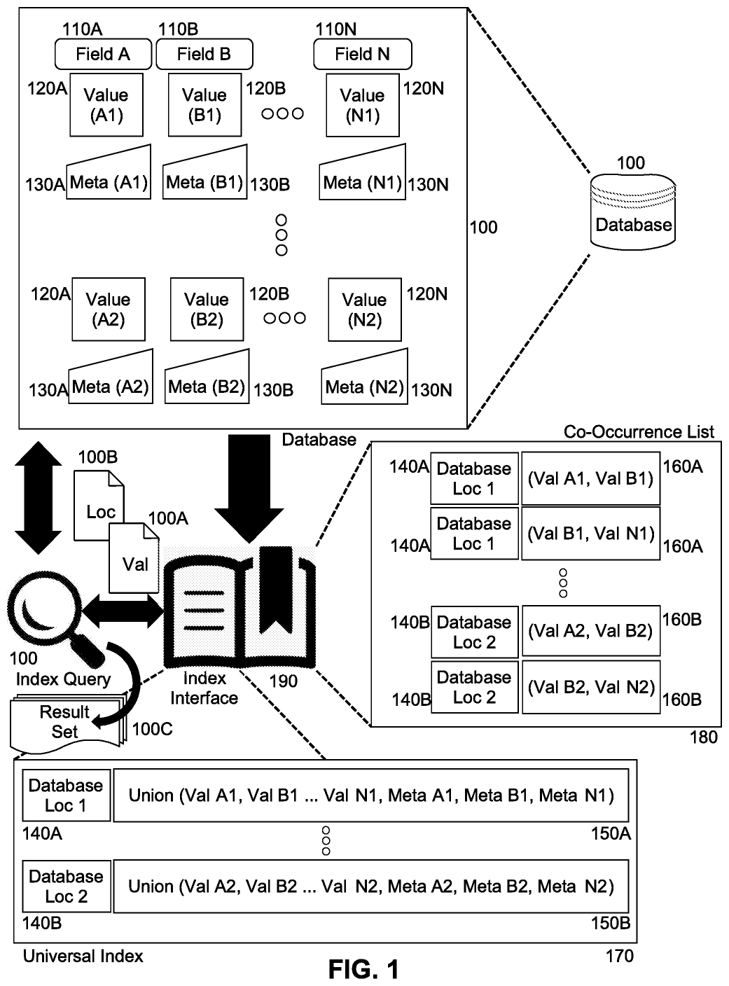

In further illustration, Figure pictorially shows a process for the generation and use of a universal database index for fast query searching of a database. As shown in FIG. 1, a database 100 includes different records of different values 120A, 120B, 120N for respectively different fields 110A, 110B, 110N, and optionally, pseudo-columns, pseudo-column values, dimensions and dimension values. Each of the different fields 110A, 110B, 110N includes meta-data 130A, 130B, 130N, for instance a name for each of the fields 110A, 110B, 110N. Each of the values 120A, 120B, 120N of the records of the database 100 are unionized into a data structure 150A, 150B such as an array, a linked list, or a simple string of delimiter separated values, to name three such examples. The data structure 150A, 150B is then stored in a universal index 170 in connection with a location 140A, 140B at which a corresponding one of the records is located in the database 100.

Of note, a co-occurrence list 180 also is generated from the universal index 170. In this regard, the co-occurrence list 180 includes, for each data structure 150A, 150B, a set of pairs of the values 120A, 120B, 120N and an association with the location 140A, 140B such that the number of pairs of the values 120A, 120B, 120N in the set is:

Σ₁^{Number of Fields-1}i

with each of the pairs of the values in the set enjoys the same location 140A, 140B in the database 100. The co-occurrence list 180 is then appended to the index 170.

Thereafter, an index interface 190 is provided through which a keyword 100A is received in an index query 100 in response to which the universal index 170 may be searched to identify a corresponding data structure 150A, 150B containing the keyword 100A and then a corresponding location 100B for the identified one of the data structures 150A, 150B. Optionally, the co-occurrence list 180 may be searched to locate not only the location 100B in the database at which one of the values 120A, 120B, 120N is found corresponding to the keyword 100A, but also co-occurring ones of the values 120A, 120B, 120N. In either instance, the index interface 190 then issues a query to the database 100 at the location 100B so as to retrieve the associated record in a result set 100C without having to engaged in resource intensive SQL querying using a WHERE directive.

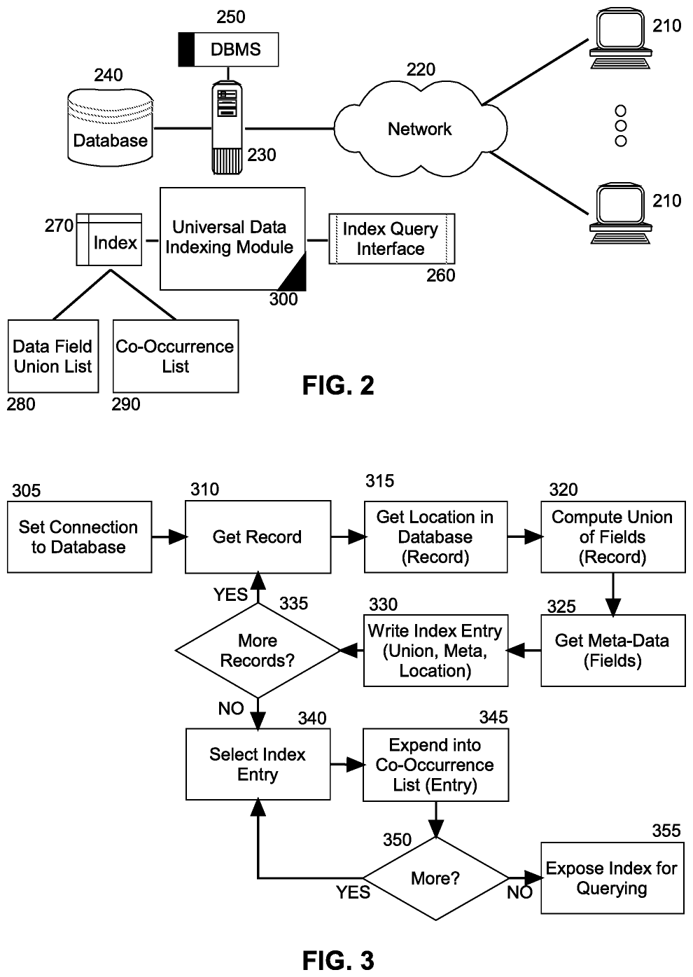

The process described in connection with FIG. 1 may be implemented in a data processing system. In further illustration, FIG. 2 schematically shows a data processing system configured for generating and utilizing a universal database index for fast query searching of a database. The system includes a host computing system 230 that includes one or more computers, each with memory and at least one processor. The host computing system is coupled to different client devices 210 over computer communications network 220. The host computing system 230 is coupled to a database 240 and supports the execution in the memory of a database management system 250 moderating access to the database 240 by different requestors issuing requests from the client devices 210 from over the computer communications network 220.

Of note, the system includes a universal data indexing module 300 that includes computer program instructions executing in the memory of the host computing system 230. The program instructions are enabled during execution to generate an index 270 to the database 240 by including in the index 270, a data field union list 280 of different entries, each including a union of the values of the data fields of a corresponding record in the database 240, and meta-data pertaining to the data fields, and a location in the database 240 for the corresponding record. The program instructions further are enabled during execution to include in the index 270 a co-occurrence list 290 of different pairs of the values co-occurring in the same record of the database 250 along with a corresponding location of the record in the database 250.

Finally, the program instructions are enabled to generate an index query interface 260 adapted to receive keyword queries from the client devices 210 from over the computer communications network 220. The program instructions, upon receiving a keyword query, extracts a keyword and searches the data field union list 280 of the index 270 to locate an entry including the keyword. A corresponding location value is then identified and the program instructions retrieve a record from the database 240 at the location which record is then returned through the query interface 260 to a requesting one of the client devices 210. Optionally, the program instructions are enabled to return along with the record, meta-data for a field of the record matching the keyword, for example a column name of the field so as to achieve a “reverse lookup”. As another option, the program instructions also search the co-occurrence list 290 and return in the query result other values co-occurring with a value associated with the keyword.

In even further illustration of the operation of the universal data indexing module 300, FIG. 3 is a flow chart illustrating a process for generating and utilizing a universal database index for fast query searching of a database. Beginning in block 305, a connection to a database is established and in block 310, a first record is retrieved from the database. In block 315, a location in the database is determined for the record and in block 320, a union is computed of all field values in the record and also in block 325, meta-data for each of the fields of the record. Then, in block 330 an entry is written to the universal data index including the union of values, meta-data and the location. In decision block 335, if additional records remain to be processed in the database, the process returns to block 310 in which a next record in the database is retrieved.

When, no further records in the database remain to be processed, in block block 340 a first index entry is selected for processing. In block 345, the index entry is expanded to include set of entries of co-occurring terms, each sharing the same location value for the database as the entry in the index. In decision block 350, if additional entries in the index remain to be processed, the process returns to block 340 at which a next entry in the index is selected for processing. In decision block 350, when no further entries in the index remain, in block 355 an index query interface is exposed for access by remote devices over a computer communications network.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A universal data index generation and utilization method comprising:
establishing a communicative coupling to a database by way of a database management system;
creating in an index in memory of a host computer, a union of field values in all columns of the database, with all meta-data for the columns of the database, the index associating each of the values and each of the meta-data with a specific location in the database;
adding to the index, pair-wise field values as a co-occurrence list; and,
issuing a query to the index without issuing a structured query language (SQL) WHERE statement to the database management system in order to produce a filtered query result.

2. The method of claim 1, wherein the meta-data includes a name for each of the columns.

3. The method of claim 2, wherein the query includes a query term associated with a column name of one of the columns.

4. The method of claim 2, wherein the query includes a field value and produces a name of a column containing the field value as a reverse lookup of the name of the column based upon the field value.

5. The method of claim 1, wherein the query includes a first field value and the issuing of the query produces a second field value from a corresponding one of the pair-wise field values of the co-occurrence list so as to locate the second field value as co-occurring with the first field value.

6. A data analytics data processing system configured for universal data index construction comprising:
a host computing system comprising one or more computers, each with memory and at least one processor;
a database index persistent in the memory of the host computing system; and, a universal data index construction module comprising computer program instructions executing in the memory of the host computing system, the program instructions performing:
establishing a communicative coupling to a database by way of a database management system;
creating in the database index in the memory of the host computing system, a union of field values in all columns of a database, with all meta-data for the columns of the database, the index associating each of the values and each of the meta-data with a specific location in the database;
adding to the database index, pair-wise field values as a co-occurrence list; and,
issuing a query to the database index without issuing a structured query language (SQL) WHERE statement to the database management system in order to produce a filtered query result.

7. The system of claim 6, wherein the meta-data includes a name for each of the columns.

8. The system of claim 7, wherein the query includes a query term associated with a column name of one of the columns.

9. The system of claim 7, wherein the query includes a field value and produces a name of a column containing the field value as a reverse lookup of the name of the column based upon the field value.

10. The system of claim 6, wherein the query includes a first field value and the issuing of the query produces a second field value from a corresponding one of the pair-wise field values of the co-occurrence list so as to locate the second field value as co-occurring with the first field value.

11. A computer program product for universal data index construction, the computer program product including a computer readable storage medium having program instructions embodied therewith, the program instructions executable by a device to cause the device to perform a method including:
establishing a communicative coupling to a database by way of a database management system;
creating in an index in memory of a host computer, a union of field values in all columns of the database, with all meta-data for the columns of the database, the index associating each of the values and each of the meta-data with a specific location in the database;
adding to the index, pair-wise field values as a co-occurrence list; and,
issuing a query to the index without issuing a structured query language (SQL) WHERE statement to the database management system in order to produce a filtered query result.

12. The computer program product of claim 11, wherein the meta-data includes a name for each of the columns.

13. The computer program product of claim 12, wherein the query includes a query term associated with a column name of one of the columns.

14. The computer program product of claim 12, wherein the query includes a field value and produces a name of a column containing the field value as a reverse lookup of the name of the column based upon the field value.

15. The computer program product of claim 11, wherein the query includes a first field value and the issuing of the query produces a second field value from a corresponding one of the pair-wise field values of the co-occurrence list so as to locate the second field value as co-occurring with the first field value.
